(19) United States
(12) Patent Application Publication
(10) Pub. No.: US 2018/0132062 A1
(43) Pub. Date: May 10, 2018

(54) Device for Locating Mobile Devices

(71) Applicant: V-Count Teknoloji A.S, Cankaya (TR)

(72) Inventor: Demirhan Buyukozcu, Istanbul (TR)

(73) Assignee: V-Count Teknoloji A.S, Cankaya (TR)

(21) Appl. No.: 15/392,603

(22) Filed: Dec. 28, 2016

(30) Foreign Application Priority Data
Nov. 8, 2016 (EP) 16197725.1

(51) Int. Cl. H04W 4/02; H04B 17/309; H04W 4/00

(52) U.S. Cl. CPC H04W 4/023; H04W 4/008; H04B 17/309

(57) ABSTRACT

Devices for locating mobile devices that solve various technical problems in the art are described. The devices may include a base body comprising a plurality of interfaces and each interface may be adapted for receiving a wireless signal transceiver. The devices also may include one or more shielding components arranged between the interfaces for limiting a detection area of the wireless signal transceivers. The devices also may include a processor that is operable to determine a signal strength of signals received from a mobile device at each of the wireless signal transceivers and to determine a location of the mobile device based on the determined signal strengths.

This application claims benefit of European Patent Application No. 16197725.1 filed Nov. 8, 2016, which is incorporated by reference in its entirety.

### 1. TECHNICAL FIELD

The present invention generally relates to the field of locating mobile devices, and more particularly to a device for locating mobile devices based on wireless signals.

### 2. THE PRIOR ART

Various technologies for locating mobile devices, such as smart phones, smart watches, tablets, laptop computers or the like, are known in the art. One way of doing so is by using wireless communication technologies.

For example, US 2010/0238083 A1 discloses a unitized device and method to optimize directional antenna alignment for long-distance communications using the low-cost IEEE 802.11 and related compatible RF-chipsets which are originally designed for short range Wireless-LAN and Wireless-PAN networks. It may be used for driving a directional antenna towards mobile devices with wireless signals in order to locate the mobile devices. However, this requires constantly redirecting the single directional antenna towards the mobile devices, which is difficult to realize.

US 2014/0132412 A1 discloses a short-distance tracking system for persons or objects consisting in the use of a Wi-Fi-emitting device, for example a key fob, carried by the person or object to be tracked, and the Wi-Fi receptor of a smart mobile phone as tracker unit. An application running on the mobile phone can show the distance of the specific device emitting the wireless signal, depending on the detected attenuation level. When the distance increases, the signal will show an attenuation and the application running on the phone will prompt the user to move towards the direction in which the signal intensifies. As the mobile phone approaches the device, the signal will intensify and the application will prompt the user to continue moving in the same direction. However, this approach only indicates the distance of the two interacting devices to one another, but does not enable to locate a wireless mobile device. Further, this requires an additional application to be run on one mobile device, so that the approach cannot be used for mobile devices that do not have the appropriate application installed.

US 2008/0161011 A1 discloses a method and electronic device for determining a location of a mobile device. A receiver may asynchronously receive an access signal from at least three access points of a wireless local area network with the mobile device. A processor may measure an access signal strength for the access signal for each access point. A transmitter may transmit the access signal strengths to a location server to determine the location of the mobile device. However, this requires at least three separate access points and that the access points communicate over a network with a location server. This approach therefore requires a complex distributed hardware architecture and extensive computing and communication efforts.

US 2014/0274112 A1 discloses determining a location of a mobile device based on wireless signals received by one or more other devices. The wireless signals are received by the other devices using at least one directional antenna and/or at least one adaptive array antenna. A location of a transmitting device is determined by two or more devices by determining a direction toward the transmitting device from each of the two or more devices based on wireless signals received by the two or more devices from the transmitting device. The location of the transmitting device is determined based on the location of the two or more devices and the intersection of respective projections directed toward the transmitting device from the two or more devices. However, this requires either directional antennas or at least a plurality of access points. Further, this requires much computing effort in order to locate a wireless mobile device.

It is therefore the technical problem underlying the present invention to provide a device for locating mobile devices which has a simple construction, reduces the amount of communication over the network, reduces the computational effort for locating a mobile device and/or is applicable to a wide range of mobile devices to be located, thereby at least in part overcoming the disadvantages of the prior art.

### 3. SUMMARY OF THE INVENTION

The invention is defined by the independent claims. Advantageous modifications of embodiments of the invention are defined in the dependent claims.

In some embodiments, a device for locating mobile devices is provided. The device may include a base body comprising a plurality of interfaces, and each interface may be adapted for receiving a wireless signal transceiver. One or more shielding components may be provided, and each shielding component may be arranged between the at least two of the interfaces for limiting a detection area of the wireless signal transceivers. A processor also may be provided that is operable to determine a signal strength of signals received from a mobile device at each of the wireless signal transceivers and to determine a location of the mobile device based on the determined signal strengths.

Accordingly, only one single device is needed to locate mobile devices. By only needing a single device a greater ease of installation can be provided to users of the device. Further, there is no need for extensive communication between multiple devices. Further, the device may be constructed of multiple ordinary hardware parts. Furthermore, the number of wireless signal transceivers can be increased in order to gain more precise results for the location of the mobile devices.

In an aspect, the shielding components may be made of a material that can generate electromagnetic shielding, such as sheet metal, a metal screen, a metal foam and/or aluminium. Accordingly, the shielding components can be formed without the need for expensive processing steps as ordinary materials can be used as shielding components.

In another aspect, the shielding components may be made of a material that shields at least 60% of wireless signals. Accordingly, also cheaper materials can be used for shielding components which would not jeopardize the device for locating mobile devices.

In yet another aspect, the interfaces may be USB interfaces and the wireless signal transceivers may be USB dongles. Accordingly, the device can be built of ordinary off-the-shelf hardware parts which are inexpensive and simple to buy. Further, no custom hardware needs to be built which may speed up the production process.

In another aspect, the processor may be operable to determine a location of the mobile device by determining that the mobile device is located within a reception area of the wireless signal transceiver with the maximum signal strength. Accordingly, no resource intensive calculation steps need to be calculated by the device.

In another aspect, the signals received from the mobile device may be WiFi signals and/or Bluetooth signals. Accordingly, the invention is not limited to a specific communication standard. To the contrary, a mobile device may be located by the device using any electro-magnetic wave.

In yet another aspect, the signals received from the mobile device may be signals used by the mobile device for sensing wireless networks. Correspondingly, the mobile devices that shall be detected may not need to install a particular software prior to be detected by the device. Instead, any mobile device which regularly senses available wireless networks within its vicinity, such as modern smartphones, may be used with the provided device. This way, it is possible to reliably locate users, since virtually any user nowadays carries a corresponding mobile device.

In an aspect, the device may be capable of distinguishing multiple mobile devices based on an identifier comprised in the received signals. Accordingly, the device may detect multiple mobile device simultaneously in an unintrusive manner.

In another aspect, the shielding components may be arranged between the interfaces in such a way that the wireless signal transceivers each cover the same amount of a circular plane. Correspondingly, the device may provide the same exactness for the location of a mobile device irrespective of the wireless signal transceiver by which the signal of the mobile device has been detected.

In yet another aspect, the processor may be further operable to determine a distance between the mobile device and the device based on the received signal strengths. Correspondingly, the preciseness of the location of the mobile device may be increased.

In one aspect, the shielding components may be in physical contact with the processor to provide a cooling for the processor, wherein the shielding components preferably comprises a plurality of cooling fins. Accordingly, the device may avoid an overheating of its internal components during operation. Correspondingly, the lifetime of the device may be increased.

In yet another aspect, the device comprises exactly two wireless signal transceivers, and determining a location of the mobile device comprises determining whether the mobile device is located inside or outside a specific venue. Accordingly, the device may be simple to construct and may need few parts. Further, in many cases a binary decision may be sufficiently accurate.

Additionally or alternatively the device may be arranged at a border area of the venue, e.g. the device may be mounted over an entrance of the venue, such as the door of a shop. Correspondingly, the device may be installed easily.

Additionally or alternatively the interfaces may be arranged such that the two wireless signal transceivers extend in a direction parallel to each other, and wherein the shielding components comprise a shape such that the two wireless signal transceivers have distinct reception areas. Accordingly, ordinary hardware parts may be used to construct the device, e.g. a raspberry pi, two Wifi dongles, and a shielding component. Correspondingly, the device may be constructed in a simple and cheap manner.

The present invention also provides a system comprising a plurality of the above-described devices. Accordingly, large venues where a single device of the invention may be insufficient can be monitored for mobile devices.

### 4. SHORT DESCRIPTION OF THE DRAWINGS

In the following detailed description, presently preferred embodiments of the invention are further described with reference to the following figures.

FIGS. 1a-1b show a top view and a bottom view, respectively, of an exemplary base body of an exemplary device for locating mobile devices;

FIGS. 2a-2c show perspective views of exemplary interfaces adapted for receiving wireless transceivers of an exemplary device for locating mobile devices;

FIGS. 3a-3c show perspective views of exemplary shielding components arranged between exemplary interfaces of the base body of a device for locating mobile devices;

FIGS. 4a-4b show perspective views of exemplary base body and exemplary shielding components of an exemplary device for locating mobile devices;

FIG. 5 shows a schematic overview of an exemplary system including an exemplary device for locating mobile devices;

FIGS. 6a-6b show schematic diagrams illustrating an exemplary arrangement of exemplary wireless transceivers;

FIGS. 7a-7c show schematic overview of exemplary systems comprising a plurality of exemplary devices for locating mobile devices;

FIG. 8 shows a general structure of an exemplary device for locating mobile devices;

FIG. 9 shows a flow chart for an exemplary method for locating a mobile device; and

FIG. 10 shows a flow chart for an exemplary method for selecting a transceiver from a sample of received wireless signals.

### 5. DETAILED DESCRIPTION OF PREFERRED EMBODIMENTS

In the following, presently preferred embodiments of the invention are described with respect to a device for locating mobile devices.

Hardware Overview

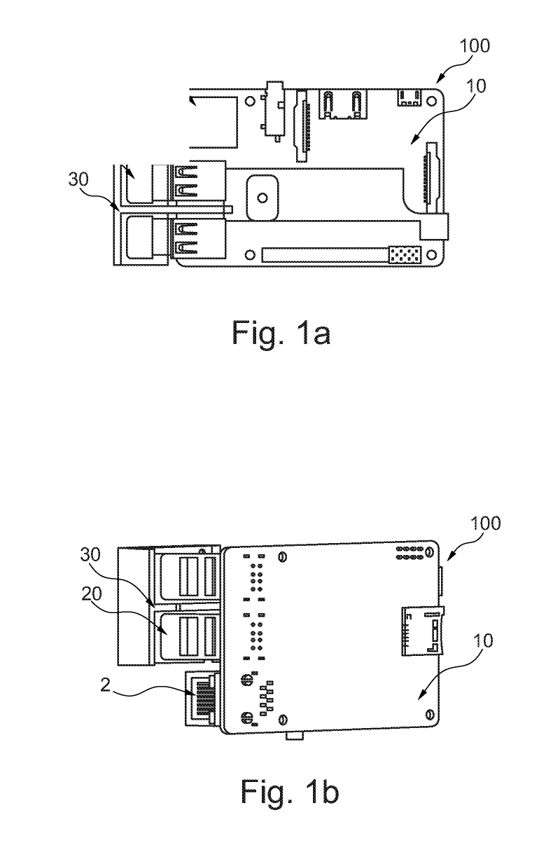

FIGS. 1a and 1b show a hardware architecture of a device 100 according to an embodiment in a top view and a bottom view, respectively. As can be seen, the device 100 comprises in this embodiment a base body 10 with four USB interfaces 1. Two of the four interfaces 1 are equipped with wireless signal transceivers 20 (in this case USB WiFi dongles). It will be understood that embodiments of the invention may comprise any number of USB interfaces 1, depending on the particular use case.

Further, the device 100 comprises an Ethernet plug 2, a CPU (central processing unit) 3 and a memory 4. The memory 4 may serve to store information about the mobile devices 200 and the like that the device 100 for locating mobile devices 200 detects. Lastly, the figure shows a shielding component(s) 30 arranged between the interfaces 1 for limiting a detection area of the wireless transceivers 20, which will be described in more detail further below.

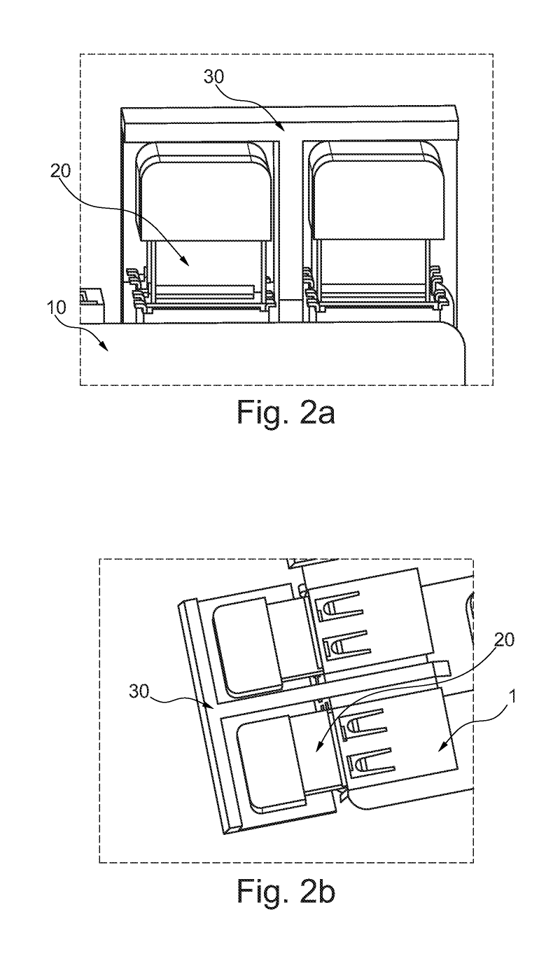

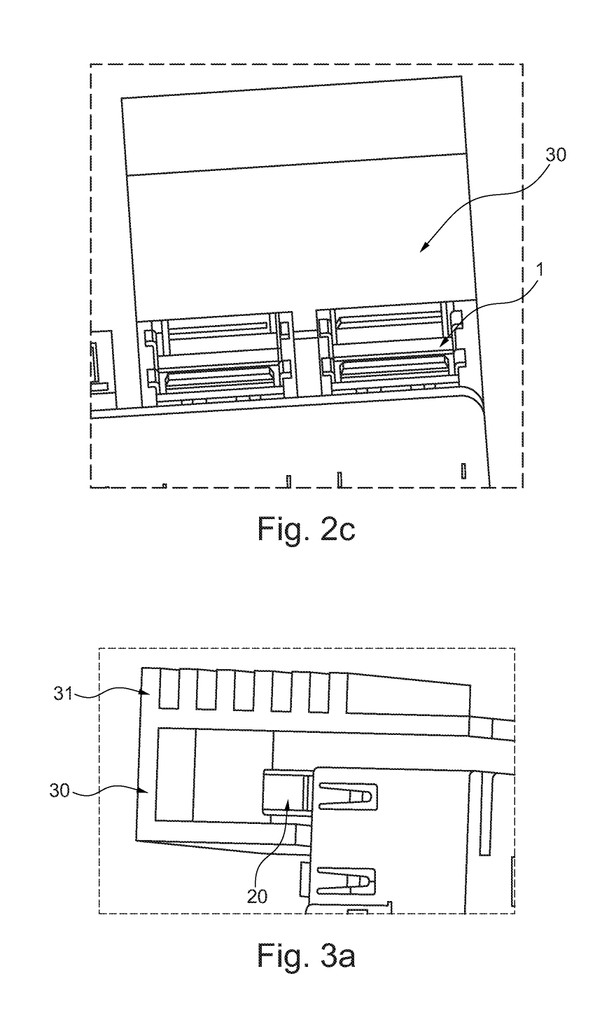

FIGS. 2a-c show the USB interfaces 1 and attached wireless signal transceivers 20 in more detail. As can be seen, the shielding 30 forms in this embodiment a box-like structure around each wireless signal transceiver 20 with two open sides, namely one open lateral side (i.e. perpendicular to a main axis of the transceiver dongle 20) and one open bottom side. The purpose of the shielding 30 is to block signals into the defined targeted area of the corresponding USB dongle 20. The shape of the shielding 30 can vary according to USB dongle shape and/or attachment position to the base body 10. In this figure, the dongles 20 are covered to send their signals only to one side of the device 100 so that two separate regions can be detected. The covered area will vary according to the shape of the shielding component(s) 30.

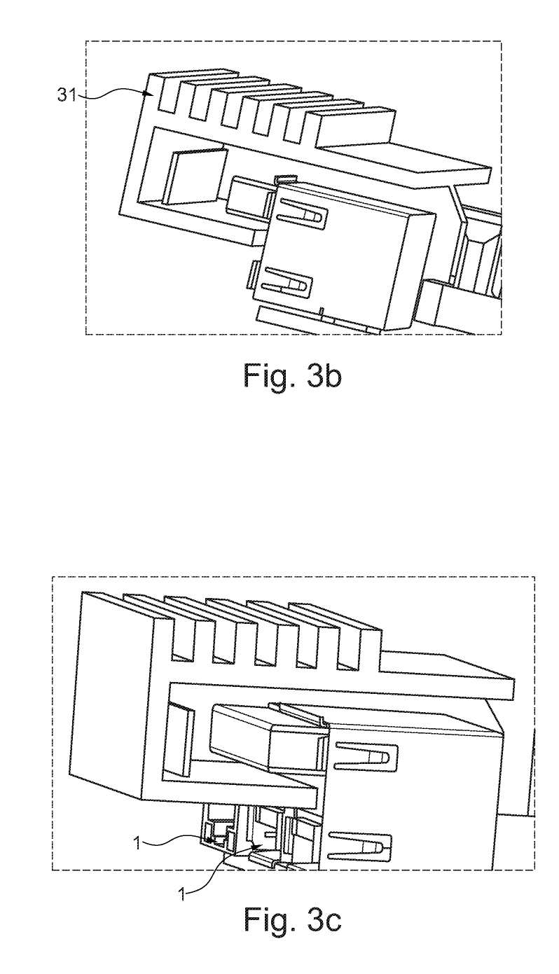

FIG. 3a shows again two USB interfaces 1, each adapted for receiving a wireless signal transceiver 20. Further, the figure shows a shielding component 30 arranged between the interfaces 1 for limiting a detection area of the wireless transceivers 20. Lastly, the figure shows that the shielding component 30 may be formed in such a way that it forms fins 31 at the outer part of the shielding. These fins 31 may serve as heatsink. In some embodiments, the shielding component(s) 30 may touch partially or cover up the whole CPU (central processing unit) 3 and/or PCB (printed circuit board) 6 in order to further regulate the heat in the device 100.

FIGS. 3b and 3c show the same embodiment as FIG. 3a but from another perspective. As a result of the different perspectives, different parts of the base body 10 are depicted.

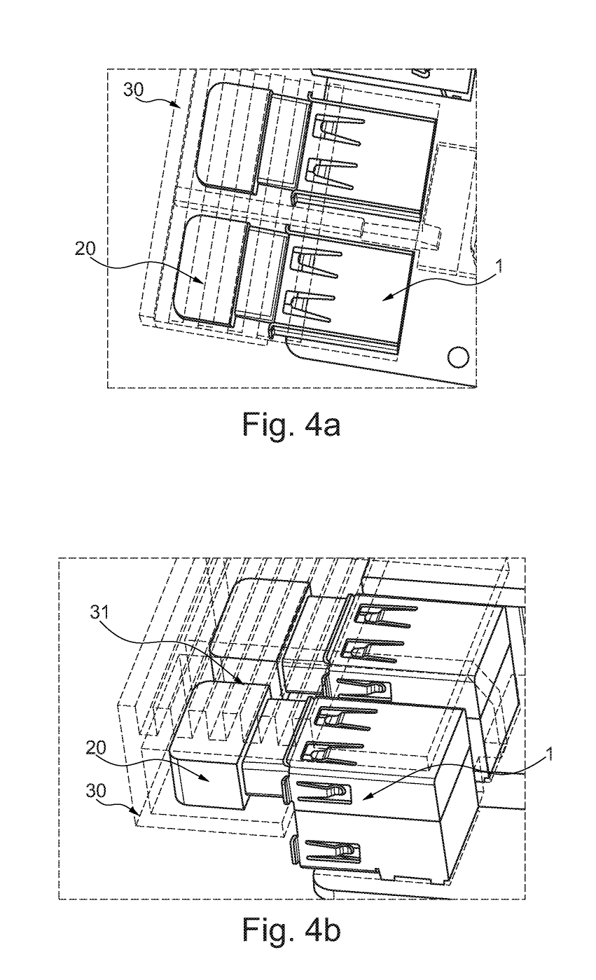

FIGS. 4a and 4b show further views of the above embodiment, wherein the shielding 30 is drawn in a transparent manner to reveal the components underneath.

Exemplary Use Case of the Device

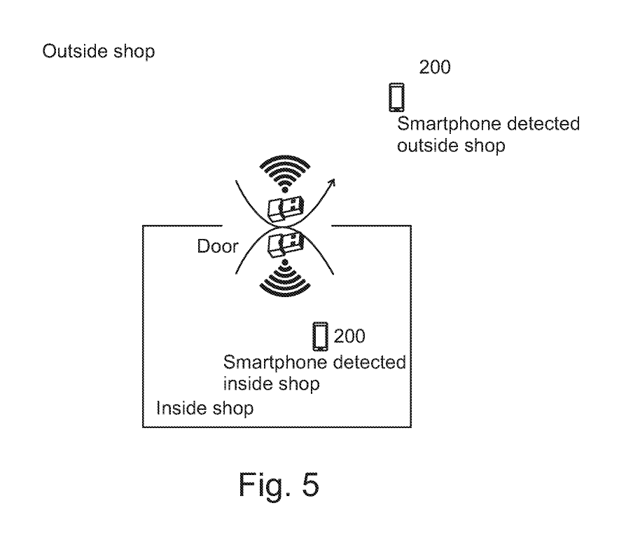

FIG. 5 shows an example of the device 100 used in a people counting use case. While the device 100 may be used in conjunction with camera people counting technology (not depicted in FIG. 5) this is not required.

The device 100 comprises in this embodiment two (preferably exactly two) wireless transceivers 20 that are shielded, leading to modified directional antennas. The device 100 may be placed at the door of a shop. Hence, the device 100 is able to detect any mobile phone 200 (or other mobile device) near the device 100. Further, it may be able to determine whether the mobile phone 200 is inside the shop or outside the shop with the help of real time comparison of wireless signal data (as will be explained further below). Therefore, in this example the device 100 may be able to correctly track and analyze the customer data with only one device 100 placed at only one position, which is a significant simplification compared to the devices known in the prior art.

Systems for locating mobile devices, in particular people counting systems begin to be more and more important for brick-and-mortar retailers to identify and capitalize on opportunities to increase sales, customer satisfaction and loyalty to the brand. To achieve these goals retailers may take advantage of customer counting systems and instore analytics technologies. Therein, wireless technologies may be used to track smartphone signals of customers and creating unique path maps and heat maps. The device 100 according to the invention may be used for focusing on detecting a strength and a direction of wireless signals in order to determine a position of the wireless enabled devices 200 to interpret the customer behavior. This information may be used to determine conversion rate (number of store visitors/number of people passing by the shop), dwell time of customers, retention rate of customers, path map and heat map in the store and the like.

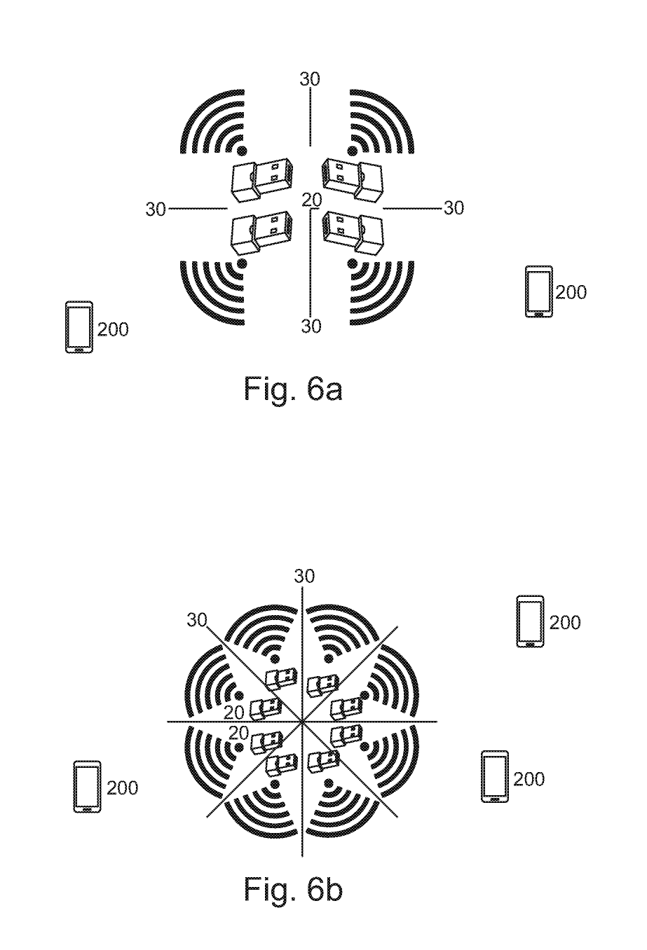

FIG. 6a shows another embodiment of the device 100 comprising four wireless transceivers 20 mounted onto the base body 10. Further, the figure depicts two exemplary mobile devices 200 that are to be located by the device 100.

FIG. 6b shows yet another embodiment of the device 100 comprising eight wireless transceivers 20 mounted onto the base body 10. Further, the figure depicts three mobile devices 200 that are to be located by the device 100.

In order to detect wireless signals, such as e.g. IEEE 802.11 signals, mobile devices 200 transmit to access points a wireless signal which is detectable and traceable using wireless signal transceivers, such as e.g. wireless USB dongles. However, the invention is not limited to IEEE 802.11 signals. It will be understood that every electromagnetic wave could be used to encode a signal, e.g. Bluetooth and the like. The wireless signal transceivers 20 can sense the signal strength of the mobile devices 200 according to the position of the transmitting mobile device 200. This information can be converted to distance information. In an embodiment of the invention, the distance may be calculated from the signal strength using the formula:

Distance [m]=10̂((27.55−(20*log 10(frequency))+signalStrength)/20)

Therein, the distance is proportional to the signal strength. Thus, a mobile device location can be determined to be on a circle that has a radius that can be calculated based on the strength of the detected wireless signal.

Wireless signals can be directed using reflector materials, such as mainly electrically conductive material which can generate electromagnetic shielding, such as e.g. sheet metal, metal screens, metal foam, and/or aluminum blocks. By using such reflector materials for the shielding component(s) 30, one may essentially construct a modified directed antenna from a conventional USB WiFi dongle and a shielding. By means of directed antenna, one may detect distinct detection areas, wherein the direction of the target can be interpreted from the signal strength.

Further, with respect to FIGS. 6a and 6b, two, four, eight, sixteen or even more wireless transceivers 20 may be mounted onto the same base body 10 of the device 100, with different angles and supporting antennas for direction sensing. In order to enable a large number of wireless transceivers 20 to be mounted onto a small base body 10, additional USB hubs 40 may be connected to the base body 10. Wireless transceivers 20 may be mounted onto the base body 20 to cover a whole 360° circular plane, wherein each wireless transceiver 20 covers the same angle. For example, 4 wireless transceivers could be used to cover each an area corresponding to 90° of the circular plane. Correspondingly, 8 wireless transceivers could be used to cover each 45° areas. Accordingly, a device 100 for locating mobile devices may have a star-like shape, as each wireless transceiver 20 may cover the same amount of degree on a circular plane. In order to shield the corresponding areas from one another, a shielding component(s) may be used, wherein the material that may be used shields preferably at least 60% of the wireless signals.

The device 100 for locating mobile devices 200 may use a plurality of wireless transceivers 20 that are converted to directed antennas for signal sensing. Therein, the number of wireless transceivers may be incremented in order to improve the accuracy of the target direction of the mobile device.

The device 100 for locating mobile devices 200 provides their users with an ease of installation as only one device needs to be installed instead of multiple devices. Further, this provides also a cost advantage. Furthermore, by using only a single device 100 to locate mobile devices, the amount of communication over the network can be reduced, as well as the computational effort for locating a mobile.

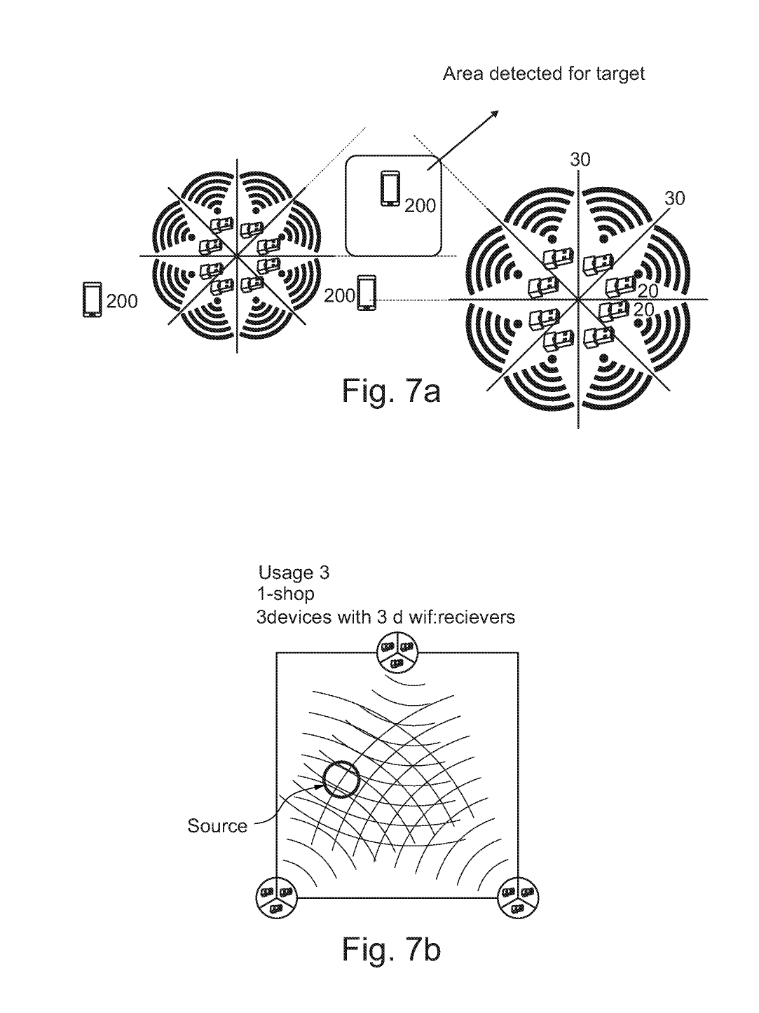

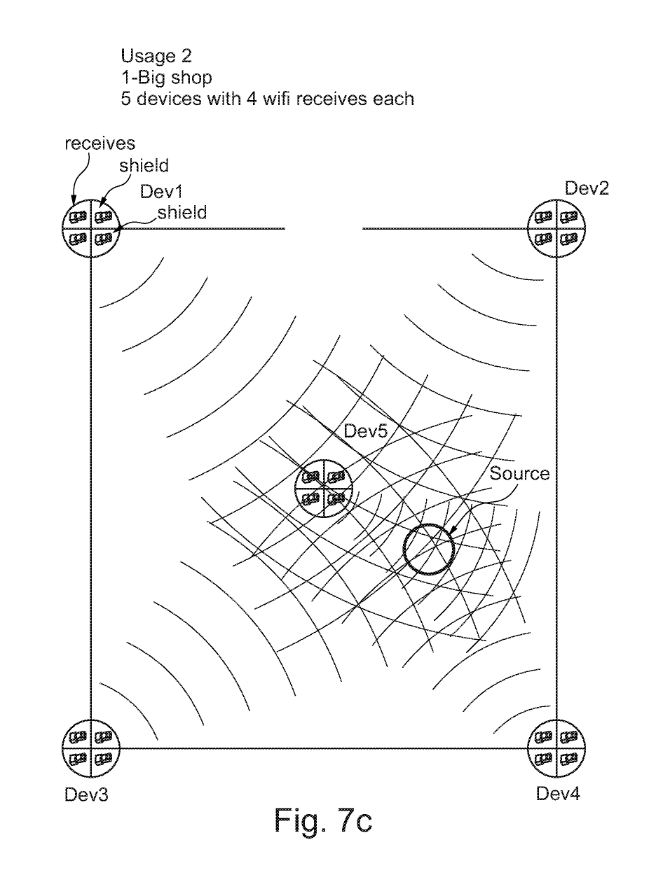

FIGS. 7a-c show exemplary use cases for devices 100 for locating mobile devices 200 in a large area. Therein, FIG. 7a shows two devices 100 for locating mobile devices, each comprising eight wireless signal transceivers 20, and three different mobile devices 200 to be located in the large area. Further, one mobile device 200 is deemed to be moving in one direction. As WiFi receivers usually have an upper limit in which they can be detected (around 70 meters), it may occur that the area in which mobile devices 200 shall be detected is larger than the area in which WiFi signals can be received (e.g. a large fair). In such a situation it may be necessary to use multiple devices 100 for locating mobile devices 200 in order to cover the whole area in which mobile devices shall be detectable. As a side effect it is to be noted that in such a situation the mobile devices can be detected even more accurately as there may be overlapping areas in between the multiple devices for locating mobile devices. Further, in such an arrangement the multiple devices 100 for locating mobile devices may transmit their received signal strengths to a server unit that may calculate a location of a mobile device in the covered area.

FIG. 7b shows a use case where there are three devices 100, each comprising three wireless signal transceivers 20, and one moving mobile device 200. Therein, two of the three devices 100 are located in the corners of the area of interest. Further, the mobile device 200 is depicted to be in a location where it can be detected from multiple devices 100.

FIG. 7c shows a use case where there are five devices 100, wherein each of the devices comprises four wireless signal transceivers 20. Further, the figure shows one moving mobile device 200 that is to be located in the large area. The arrangement of the devices 100 for locating mobile devices is such that there are four devices 100 located in the peripheral region of the area in which the mobile devices 200 are to be located, and one device 100 is placed in a central region of the area. It can be seen that the mobile device 200 is located at a region where the detection area of multiple devices 100 overlaps.

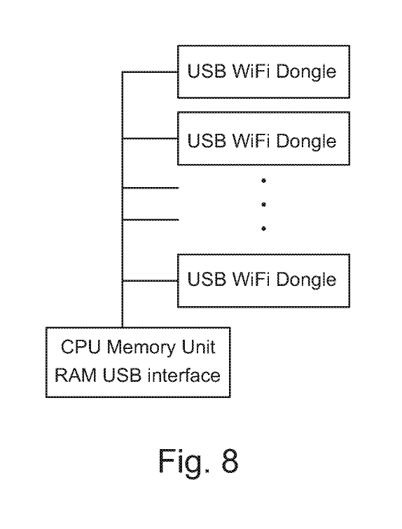

FIG. 8 shows a general structure of a device 100 for locating mobile devices 200 according to a preferred embodiment of the invention. In this specific example the base body 10 comprises a central processing unit (CPU) 3, a memory unit 4, a random access memory (RAM) 5 and a universal serial bus (USB) interface 1. Further, the figure shows three USB wireless dongles that are coupled to the base body 10. It can be derived from the figure that the base body 10 may be able to receive more wireless transceivers 20 to it.

In order to locate the mobile devices 200, the processor 3 of the device 100 is configured for determining a signal strength of signals received from a mobile device 200 at each of the wireless signal transceivers 20, and determining a location of the mobile device 200 based on the determined signal strengths. This will be explained in more detail below.

Signal Processing

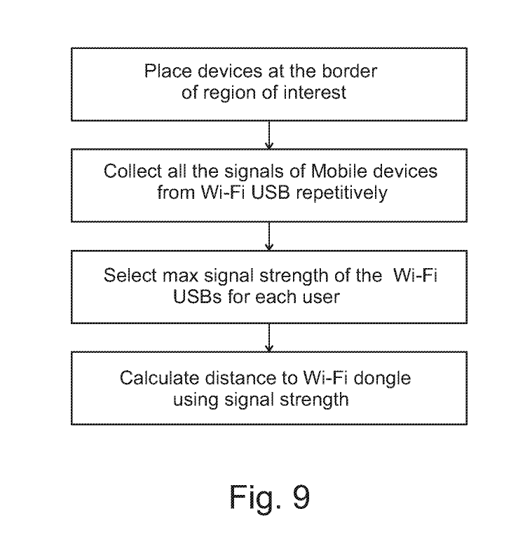

FIG. 9 shows a flowchart of a method for locating a mobile device. Therein, in the first step, the device is placed at the border of a region of interest. Therein, the region of interest corresponds to the region in which mobile devices shall be located. In the second step, wireless signals are collected/sampled, preferably repetitively. For example, the wireless transceivers of the device are sampled according to a certain time interval, e.g. 10 times per second. Said sampling may be executed by every wireless transceiver of the device by listening and/or receiving specific signal frames that mobile devices send in order to detect nearby access points, e.g. beacon frames. A reply to such a signal frame may include the name of the network (e.g. SSID, ESSID), whether encryption is used (and if so, what encryption is used, a supported data rates, and/or channel information about the network. Every wireless transceiver may have a unique MAC address (e.g. 48 bit, 6 pair of hexadecimal numbers etc.). It is to be noted that by default, a NIC (network interface card) ignores traffic that is not addressed to it, which may be done by comparing the destination address of the Ethernet packet with the hardware address. However, most NICs provide modes that allows a NIC to receive all traffic on the network, even if it is not addressed to this NIC, e.g. “promiscuous mode” and “monitor mode”. This may also be referred to as “sniffing” the network. Each sample may result in a list of detected mobile devices for every wireless transceiver of the device. This list may include the strength of the received wireless signals from every detected mobile device.

In the third step, for each user, respectively his corresponding mobile device, the device selects the transceiver which received the maximum signal strength as the corresponding receiver to said mobile device.

In the fourth step, the distance from the corresponding wireless transceiver is calculated using the received signal strength. Therein, the distance is proportional to the signal strength. The distance may be calculated by the formula:

Distance [m]=10̂((27.55−(20*log 10(frequency))+signalStrength)/20)

In addition to the foregoing, the received signal strength at the wireless transceivers may be used to compute a distance measure based on the signal strength, e.g. using the formula above. Accordingly, this may result in a direction in a slice of a circular plane and a calculated distance from the wireless transceiver. Therein, this information may be computed to be a vector from corresponding wireless transceiver towards a mobile device. This may result in polar coordinates from the device for locating mobile devices towards a mobile device that has been detected by the device.

It shall be appreciated that embodiments of the invention may realize all or only a subset of the method steps explained above.

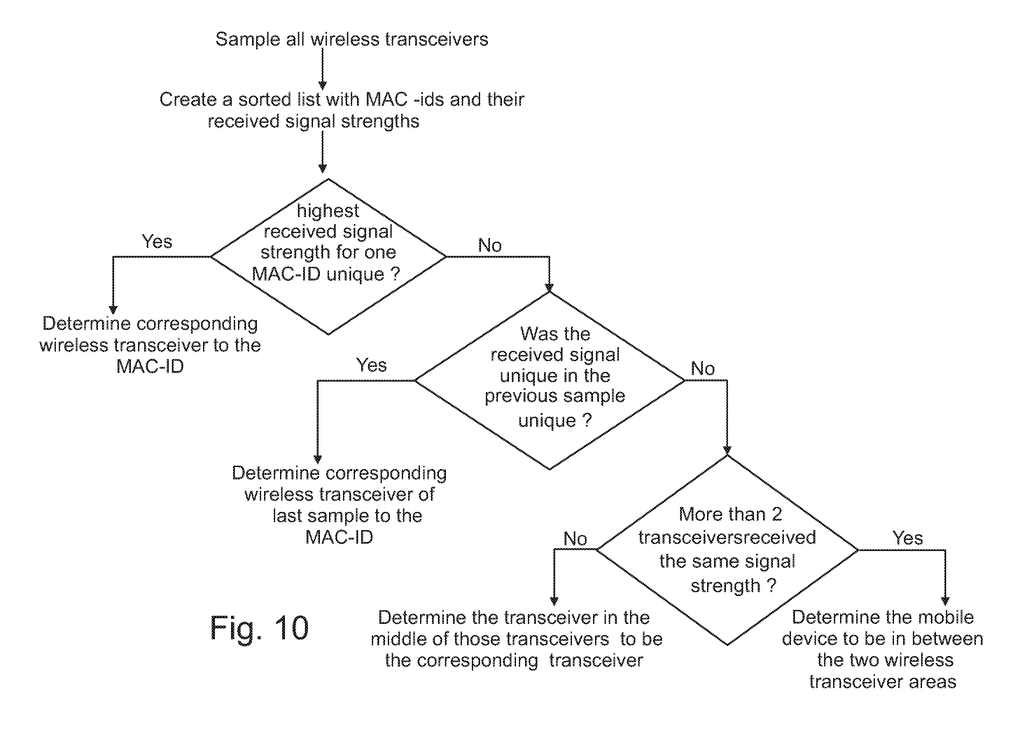

FIG. 10 shows a flowchart, wherein the third step of the method of FIG. 9 is illustrated in more detail. Therein, in step 2, the processor may group the received wireless signals according to their MAC-ID. Then, in step 3, the processor may sort the signals of all the MAC-IDs according to signal strengths individually into lists for each MAC-ID. Then, in step 4, the corresponding region may be determined based on the received signal strength for each MAC-ID signal list. Therein, in step 4.1 it may be determined whether the highest value of the signal strength is unique and if so, the mobile device is assigned to the corresponding wireless transceiver. If the highest value of the signal strength is not unique, it is determined whether in the previous sample the highest value was unique, and if so, setting the previously determined wireless transceiver to the current transceiver again. If in the previous sample, there was no unique highest value, then the number of mobile device is determined. Therein, it may appear that the multiple wireless transceivers are neighboring transceivers with respect to their physical arrangement in the base body. In this case the mobile device is determined to be located at the intersecting line of the two wireless transceivers.

1. A device for locating mobile devices, comprising:
a base body comprising a plurality of interfaces, each interface adapted for receiving an associated wireless signal transceiver;
one or more shielding components, each shielding component arranged between at least two of the interfaces and operable to limit a detection area of the wireless signal transceivers associated with the at least two of the interfaces; and
a processor operable to:
determine a signal strength of signals received from a mobile device at each of the wireless signal transceivers; and
determine a location of the mobile device based on the determined signal strengths.

2. The device of claim 1, wherein the one or more shielding components are made of a material that can generate electromagnetic shielding.

3. The device of claim 1, wherein the one or more shielding components are made of a material that shields at least 60% of wireless signals.

4. The device of claim 1, wherein the interfaces are USB interfaces and the wireless signal transceivers are USB dongles.

5. The device of claim 1, wherein the processor is further operable to determine a location of the mobile device by determining that the mobile device is located within a reception area of the wireless signal transceiver with the maximum signal strength.

6. The device of claim 1, wherein the signals received from the mobile device are either WiFi signals, Bluetooth signals, or both.

7. The device of claim 1, wherein the signals received from the mobile device are signals used by the mobile device for sensing wireless networks.

8. The device of claim 1, wherein the processor is further operable to distinguishing multiple mobile devices based on an identifier in the received signals.

9. The device of claim 1, wherein the one or more shielding components are arranged between the interfaces in such a way that the wireless signal transceivers each cover the same amount of a circular plane.

10. The device of claim 1, wherein the processor is further operable to determine a distance between the mobile device and the device based on the received signal strengths.

11. The device of claim 1, wherein at least one of the one or more shielding components is in physical contact with the processor to provide a cooling for the processor.

12. The device of claim 1, wherein the device comprises exactly two wireless signal transceivers, and wherein determining a location of the mobile device comprises determining whether the mobile device is located inside or outside a specific venue.

13. The device of claim 12, wherein the device is arranged at a border area of the venue.

14. The device of claim 12, wherein the interfaces are arranged such that the two wireless signal transceivers extend in directions parallel to each other, and wherein the shielding component comprises a shape such that the two wireless signal transceivers have distinct reception areas.

15. A system comprising a plurality of devices for locating mobile devices, each of the plurality of devices comprising:
a base body comprising a plurality of interfaces, each interface adapted for receiving an associated wireless signal transceiver;
one or more shielding components, each shielding component arranged between at least two of the interfaces and operable to limit a detection area of the wireless signal transceivers associated with the at least two of the interfaces; and
a processor operable to:
determine a signal strength of signals received from a mobile device at each of the wireless signal transceivers; and
determine a location of the mobile device based on the determined signal strengths.

16. The system of claim 15, wherein the one or more shielding components are made of a material that can generate electromagnetic shielding and that shields at least 60% of wireless signals.

17. The system of claim 15, wherein the interfaces are USB interfaces and the wireless signal transceivers are USB dongles

18. The system of claim 15, wherein the signals received from the mobile device are signals used by the mobile device for sensing wireless networks and each processor is further operable to distinguishing multiple mobile devices based on an identifier in the received signals.

19. The system of claim 15, wherein at least one of the one or more shielding components in each of the plurality of devices is in physical contact with the device's processor to provide a cooling for the processor.

20. The system of claim 15, wherein each device comprises exactly two wireless signal transceivers, wherein determining a location of the mobile device comprises determining whether the mobile device is located inside or outside a specific venue, and wherein at least one of the plurality of devices is arranged at a border area of the venue.
